(19) United States
(12) Patent Application Publication
(10) Pub. No.: US 2015/0201199 A1
(43) Pub. Date: Jul. 16, 2015

(54) SYSTEMS AND METHODS FOR FACILITATING VIDEO ENCODING FOR SCREEN-SHARING APPLICATIONS

(71) Applicants: Qunshan Gu, Hayward, CA (US); Wei Ja, San Jose, CA (US)

(72) Inventors: Qunshan Gu, Hayward, CA (US); Wei Ja, San Jose, CA (US)

(73) Assignee: GOOGLE INC., Mountain View, CA (US)

(21) Appl. No.: 13/313,288

(22) Filed: Dec. 7, 2011

(51) Int. Cl. H04N 7/26; H04N 19/85

(52) U.S. Cl. CPC H04N 19/167; H04N 19/85

(57) ABSTRACT

Systems and methods for facilitating video compression in screen-sharing applications are provided. In one embodiment, a method includes: determining properties of a screen, and determining properties of display regions configured for display via the screen. The method also includes generating reference buffers corresponding to the respective display regions. The reference buffers can be associated with: identifiers of the display region, and encoded bitstreams for the display regions. The encoded bitstreams can be indicative of the properties of the display regions and/or screen. The method can also include determining whether the display regions are configured to be visible or invisible on the screen, and generating the encoded bitstream for each of the display regions configured to be visible on the screen. Finally, the method can include performing video compression on contents of the display regions.

### TECHNICAL FIELD

This disclosure relates to video encoding, in general, and to video encoding in screen-sharing applications, in particular.

### BACKGROUND

Conventional video encoding schemes typically encode an entire screen notwithstanding various portions of the screen may include display regions displaying different content that may not require information transmission to a receiving device. For example, conventional video compression encoding formats and standards (e.g., H.264) have been traditionally designed for natural video compression applications. When applied to screen-sharing scenarios (e.g., screencasting and/or web conferencing applications) the tradition coding methods do not have a mechanism to efficiently utilize the characteristics of the screen, and/or display regions on the screen, to improve compression efficiency and presentation quality. Further, in traditional screen capture coding, display region movement causes large amounts of bits to be transmitted to a receiving device due to motion vector coding and/or motion compensation errors (notwithstanding, in some cases, no content in the display region on the screen has changed). Further, when a display region is re-sized, conventional video codecs lack mechanisms for handling such re-sizing efficiently.

As a result, an excessive number of bits may be transmitted to a receiving device, thereby wasting precious bandwidth and processing power. With the increase in traffic transmitted over wireless or wireline channels, and the drive to minimize devices and corresponding processing power, bandwidth and processing power are increasingly important.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its purpose is to present some concepts of one or more embodiments in a simplified form as a prelude to the more detailed description that is presented later.

In one or more embodiments, the disclosed subject matter relates to a method for facilitating video compression in screen-sharing applications. The method can include: determining properties of a screen; and determining properties of display regions configured for display via the screen. The method can also include generating reference buffers corresponding to a number of the display regions. The reference buffers can be associated with: identifiers of the display regions; and encoded bitstreams for the display regions. The encoded bitstreams can be indicative of the properties of the display regions and/or screen. The method can also include determining whether the display regions are configured to be visible or invisible on the screen, and generating the encoded bitstreams for each of the display regions configured to be visible on the screen.

In another embodiment, the disclosed subject matter relates to a system facilitating video compression in screen-sharing applications. The system can include: a memory that stores computer executable components; and a microprocessor. The microprocessor can execute the following computer executable components stored in the memory: a screen analysis component configured to determine one or more properties of a screen, and determine one or more properties of one or more display regions configured for display via the screen. Another computer executable component can include a resource allocation component configured to generate one or more reference buffers corresponding to a number of the one or more display regions. The one or more reference buffers can be associated with: identifiers of the one or more display regions; and encoded bitstreams for the one or more display regions. The encoded bitstreams can be indicative of the one or more properties of the screen and/or display regions. Another computer executable component can include a hierarchy component configured to determine whether the one or more display regions are configured to be visible or invisible on the screen; and an encoder configured to generate the encoded bitstreams for each of the display regions configured to be visible on the screen. The encoded bitstreams can include information indicative of the one or more properties for each of the one or more display regions configured to be visible on the screen. Another computer executable component can include a compression component configured to perform video compression.

In another embodiment, the disclosed subject matter relates to a method of facilitating video decompression in screen-sharing applications. The method can include: decoding encoded bitstreams of one or more reference buffers corresponding to a number of one or more display regions of a screen. The encoded bitstreams can be indicative of one or more properties of display regions of the screen and be indicative of ones of the display regions configured to be visible on the screen. The method can also include determining the ones of the display regions configured to be visible on the screen, and displaying such display regions. Displaying can include rendering the display regions configured to be visible on the screen based, at least, on the one or more properties of the display regions configured to be visible on the screen.

In another embodiment, the disclosed subject matter relates to another system facilitating video compression in screen-sharing applications. The system can include: a memory that stores computer executable components; and a microprocessor. The microprocessor can execute the following computer executable components stored in the memory: a communication component configured to receive a first stream of video information configured for display at a first display region of a screen, and receive a second stream of video information configured for display at a second display region of the screen. Another computer executable component can include a screen analysis component configured to: determine one or more properties of the screen, and determine one or more properties of the first display region and the second display region. Another computer executable component can include a hierarchy component configured to rank the first display region and the second display region based, at least, on whether the first display region or the second display region is configured to be visible on the screen. The high ranked display region can be the display regions configured to be visible on the screen. Another computer executable component can include an encoder configured to generate an encoded bitstream for the high ranked display region, the encoded bitstream including information indicative of the one or more properties of the high ranked display region. Another computer executable component can include a resource allocation component configured to generate reference buffers for the first display region and the second display region. The reference buffers can be associated with identifiers of the first display region and the second display region. One of the reference buffers for the high ranked display region can include the encoded bitstream. The resource allocation component can also be configured to delete the one or more reference buffers for the first display region and the second display region based, at least, on receipt of information indicative of the first display region or the second display region being deleted.

In another embodiment, a system configured to facilitate video decompression in a screen-sharing application is provided. The system can include: a memory that stores computer executable components; and a microprocessor. The microprocessor can execute the following computer executable components stored in the memory: a decoder configured to decode encoded bitstreams of one or more reference buffers corresponding to a number of one or more display regions of a screen. The encoded bitstreams can be indicative of one or more properties of display regions of the screen and be indicative of ones of the display regions configured to be visible on the screen. The computer executable components can also include a decoder management component comprising: a screen analysis component configured to determine the ones of the display regions configured to be visible on the screen; and a rendering component. The rendering component can be configured to display the display regions determined by the screen analysis component to be configured to be visible on the screen. The rendering component can be configured to display the display regions configured to be visible on the screen based, at least, on one or more properties of the display regions.

In another embodiment, another system configured to facilitate video decompression in a screen-sharing application is provided. The system can include: a memory that stores computer executable components; and a microprocessor. The microprocessor can execute the following computer executable components stored in the memory: a screen analysis component configured to receive encoded bitstreams indicative of video information for display on a first display region and a second display region of a screen. The encoded bitstreams can be comprised in respective reference buffers associated with the first display region and the second display region. The decoder can be configured to decode the encoded bitstreams. The rendering component can be configured to display the video information for display on the first display region and the second display region of the screen.

Toward the accomplishment of the foregoing and related ends, the one or more embodiments include the features hereinafter fully described and particularly pointed out in the claims. The following description and the annexed drawings set forth herein detail certain illustrative aspects of the one or more embodiments. These aspects are indicative, however, of but a few of the various ways in which the principles of various embodiments can be employed, and the described embodiments are intended to include all such aspects and their equivalents.

### BRIEF DESCRIPTION OF THE DRAWINGS

FIG. 1 is an illustration of a block diagram of an exemplary non-limiting system configured to facilitate video compression in a screen-sharing application.

FIG. 2 is an illustration of a block diagram of an exemplary encoder management component configured to facilitate video compression in a screen-sharing application.

FIG. 3 is an illustration of a block diagram of an exemplary decoder management component configured to facilitate video decompression in a screen-sharing application.

FIG. 4 is an illustration of a flow diagram of an exemplary non-limiting embodiment facilitating video compression in a screen-sharing application.

FIGS. 5A, 5B, 6A, 6B, 7A and 7B are illustrations of schematic diagrams of exemplary non-limiting screens for which video compression in a screen-sharing application can be facilitated.

FIGS. 8A, 8B, 9, 10 and 11 are illustrations of exemplary flow diagrams of methods for facilitating video compression in a screen-sharing application.

FIG. 12 is an illustration of an exemplary flow diagram of method for facilitating video decompression in a screen-sharing application.

FIG. 13 is an illustration of a schematic diagram of an exemplary networked or distributed computing environment for implementing one or more embodiments described herein.

FIG. 14 is an illustration of a schematic diagram of an exemplary computing environment for implementing one or more embodiments described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a more thorough understanding of one or more embodiments. It is evident, however, that such embodiments can be practiced without these specific details. In other instances, structures and devices are shown in block diagram form in order to facilitate describing one or more embodiments.

Systems and methods described herein relate to video encoding and decoding in screen-sharing applications. For example, properties of a screen, and/or properties of one or more display regions on the screen, are analyzed to determine whether to encode various portions of the screen and/or display regions. The properties can include, but are not limited to, those related to the number of display regions, layer of a display region, display region starting position, display region size, change in content, re-sizing, movement of display regions or the like. A resource buffer can be associated with a respective display region and an encoded bitstream for the display region. As such, a resource buffer can be allocated for a specific display region and be associated with information for the specific display region. The encoded bitstream can be indicative of the properties of the screen and/or display region. Further, only selected display regions may be encoded, based on the properties of the display regions. The information can be transmitted to the decoder system. The decoder system can receive the information, and separately decode information associated with different resource buffers (and thereby associated with different display regions). Further, the display can be according to the properties of the screen and/or display regions.

The systems and methods can advantageously reduce the bandwidth use (thereby improving bandwidth efficiency) during transmission of video information, and can reduce processing power utilized during encoding and decoding. Screen-sharing applications that can utilize these systems and/or methods include, but are not limited to, web conferencing and/or screencasting systems and/or methods.

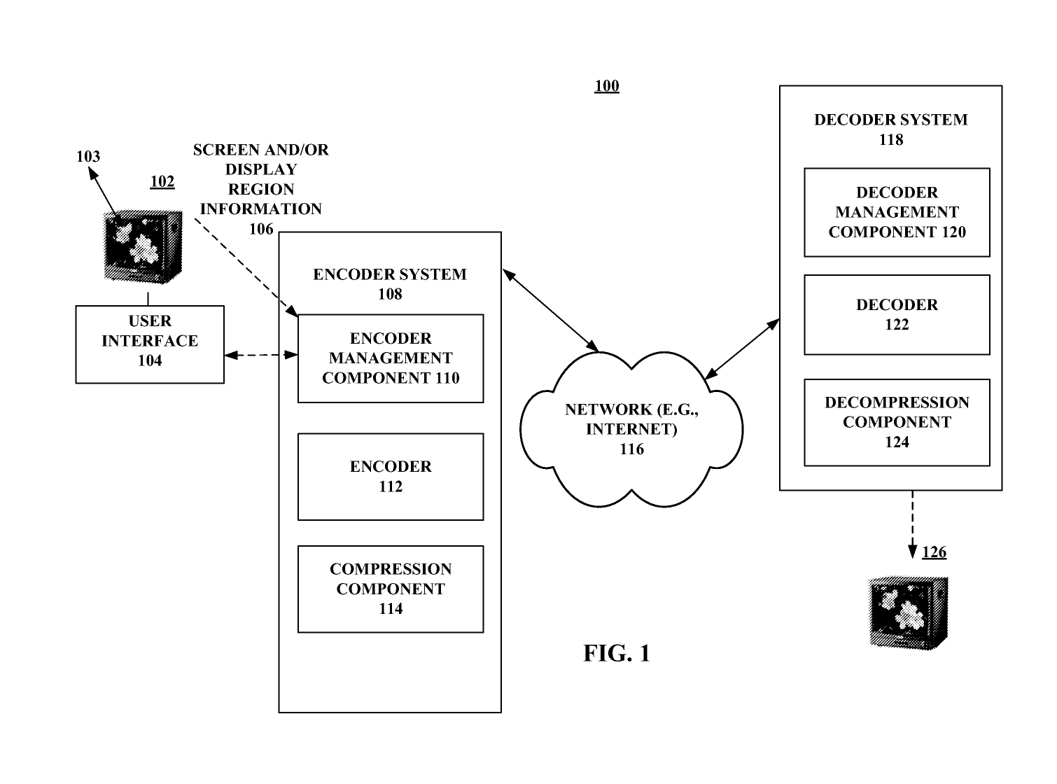

FIG. 1 is an illustration of a block diagram of an exemplary non-limiting system configured to facilitate video compression in a screen-sharing application. System 100 can include an encoder system 108 and a decoder system 118. In some embodiments, as shown, the system 100 can also include user terminals 102, 126 and at least one user interface 104. The encoder system 108 and decoder system 118 can be communicatively coupled to one another for transmitting and receiving compressed video information via a network 116. For example, as shown, the network 116 can be the internet.

The encoder system 108 can include an encoder management component 110, an encoder 112 and a compression component 114. The encoder management component 110, encoder 112 and/or compression component 114 can be electrically and/or communicatively coupled to one another to perform one or more functions of the encoder system 108.

The decoder system 118 can include a decoder management component 120, a decoder 122 and/or a decompression component 124. The decoder management component 120, decoder 122 and/or decompression component 124 can be electrically and/or communicatively coupled to one another to perform one or more functions of the decoder system 118.

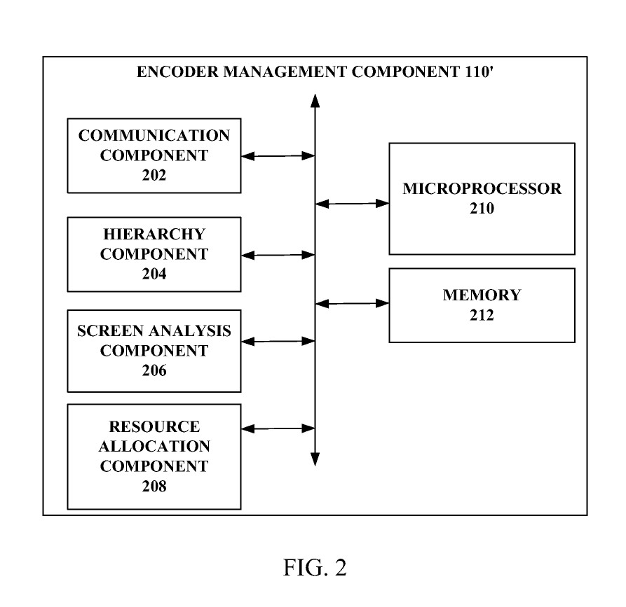

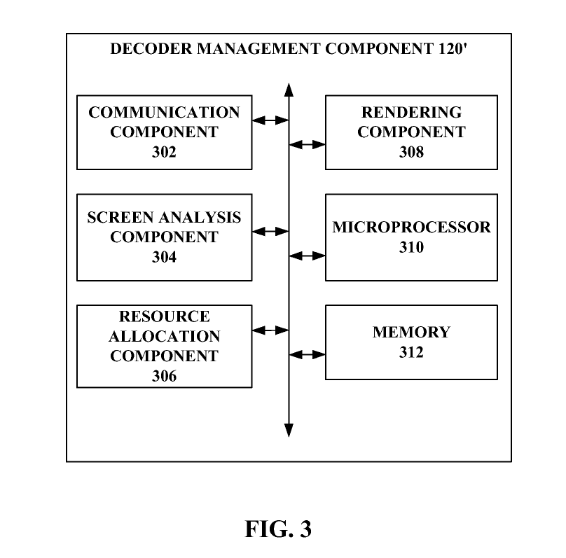

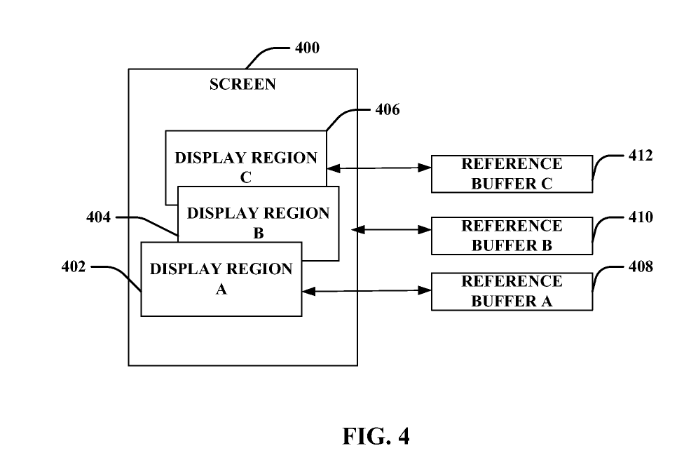

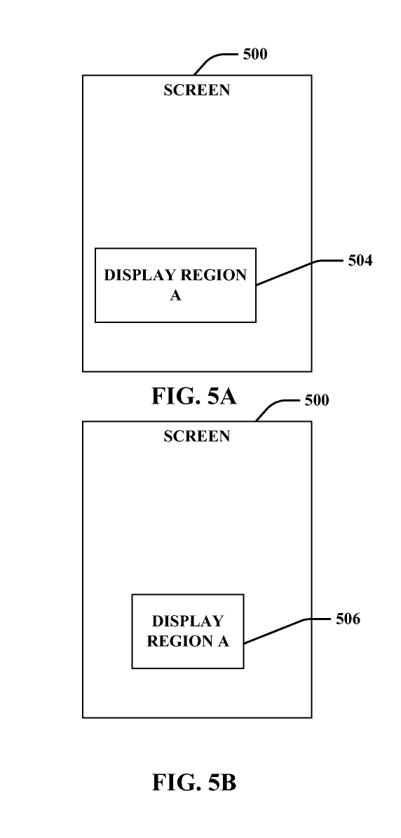

Embodiments of the structure and/or functionality of encoder system 108 and decoder system 118 will be described with regard to FIGS. 2, 3, 4, 5A, 5B, 6A, 6B, 7A and 7B. FIG. 2 is an illustration of a block diagram of an exemplary non-limiting device (e.g., encoder management component 110′) configured to facilitate video compression in a screen-sharing application. FIG. 3 is an illustration of a block diagram of an exemplary non-limiting device (e.g., decoder management component 120′) configured to facilitate video decompression in a screen-sharing application. The encoder management component 110′ and the decoder management component 120′ can include the structure and/or functionality of the encoder management component 110 and decoder management component 120 of FIG. 1 in some embodiments. FIG. 4 is an illustration of a flow diagram of an exemplary non-limiting embodiment facilitating video compression in a screen-sharing application. FIGS. 5A, 5B, 6A, 6B, 7A and 7B are illustrations of schematic diagrams of exemplary non-limiting screens for which video compression in a screen-sharing application can be facilitated.

Turning first to FIGS. 2 and 3, the encoder management component 110′ can include a communication component 202, a hierarchy component 204, a screen analysis component 206, a resource allocation component 208, a microprocessor 210 and/or a memory 212. In various embodiments, one or more of the communication component 202, hierarchy component 204, screen analysis component 206, resource allocation component 208, microprocessor 210 and/or memory 212 can be electrically and/or communicatively coupled to one another to perform one or more of the functions of the encoder management component 110′.

The communication component 202 can be configured to transmit and/or receive information from the user terminal 102 and/or communication channel coupling the encoder system 108 and the decoder system 118.

The screen analysis component 206 can be configured to determine one or more properties of a screen. The screen can be a personal computer (PC) screen in some embodiments. In other embodiments, the screen can include, but is not limited to, a tablet screen, a laptop screen or a mobile telephone screen. For example, as shown in FIG. 1, the screen can be screen 103, and can be included as part of a user terminal 102. The screen information can be processed by the screen analysis component 206 for the screen 103 of user terminal 102.

In some embodiments, the properties of the screen can include, but are not limited to: layer information associated with one or more display regions visible (or invisible) on the screen, a number of display regions configured for display via the screen or sizes of the display regions. For example, as shown in FIG. 4, display regions can be as shown at 402, 404, 406. The number of display regions can include the active, and/or non-active display regions and the display regions configured to be visible or invisible on the screen, in various embodiments. In some embodiments, the number of display regions can be the number of active, non-active, visible and invisible display regions on the screen. In various embodiments, when a display region is configured to be invisible on the screen, no portion of the display region is visible on the screen.

In some embodiments, determining the one or more properties of the screen can include, but is not limited to, detecting a pop-up of one or more of the display regions.

The screen analysis component 206 can also be configured to determine one or more properties of one or more display regions configured for display via the screen. The properties can include: identities of the display regions configured to be visible or invisible on the screen, information indicating whether content of the display regions are active or static, identities of display regions that are open or identities of display regions that are minimized. In some embodiments, the one or more properties of a display region can also include information indicative of whether a display region is open or closed. In some embodiments, whether the display region is open or closed can be encoded as a display region control property in the bitstream. Other properties can be driven or obtained based on actions from the human interfaces such as mouse/cursor movement (as inputs from the user interface 104 can control the display region layout), whether the display region is visible or invisible on the screen, display region location information (e.g., starting position (x coordinate, y coordinate)), display region size information (e.g., (height, width)), mouse/cursor location, and shape information. This information can be utilized during video compression to improve quality and efficiency. By separating the cursor or mouse movement, display region movement, whether the display region has been re-sized (and the manner of re-sizing if the display region has been re-sized) and/or the content change within each display region, the embodiments described herein can improve the compression efficiency for screen-sharing applications.

FIG. 4 is an illustration of a flow diagram of an exemplary non-limiting embodiment facilitating video compression in a screen-sharing application. Turning to FIG. 4, in some embodiments, the screen can be or include the screen 400. The display regions can be or include one or more of display regions A 402, display region B 404 and/or display region C 406. As shown, one or more of the display regions 402, 404, 406 can overlap a portion of another display region. In some embodiments, a display region can overlap another display region in entirety. In various embodiments, a display region can correspond to or be a display region on a screen. For example, as shown in FIG. 4, in some embodiments, display region A 402, display region B 404, and display region C 406 of screen 400 can correspond to three respective display regions open on a computer screen.

As used herein, the display regions can be located at any of a number of different layers on the screen. Numerous layers can exist on the screen as all or at least a portion of numerous display regions can be displayed on the screen. Accordingly, display regions (or a portion thereof) can be visible. Similarly, display regions can be invisible on the screen in some embodiments. In various embodiments, as described below, the layers can be associated with numerical values to facilitate transmission of information indicating the layer. By way of example, but not limitation, layer 0 can represent a layer of a display region configured to be located at a front of a screen. Layers further from the front of the screen can be assigned a higher number while layers closer to the front of the screen can be assigned a lower number. In various embodiments, display regions that are not visible on the screen have no portion of the display region displayed. Turning back to FIG. 4, in some embodiments, display region A 402 can be associated with layer 0, display region B 404 can be associated with layer 1 and display region C 406 can be associated with layer 2.

In various embodiments, the display regions can be selected by a user via a user interface (e.g., 104) to move from a higher layer to a lower layer (or vice versa).

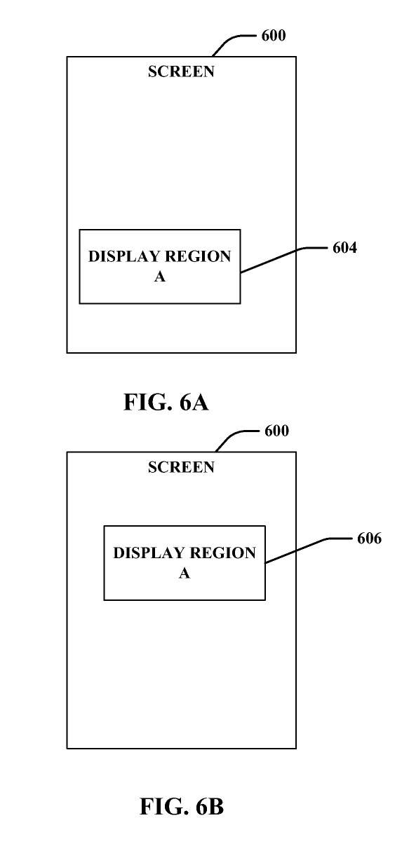

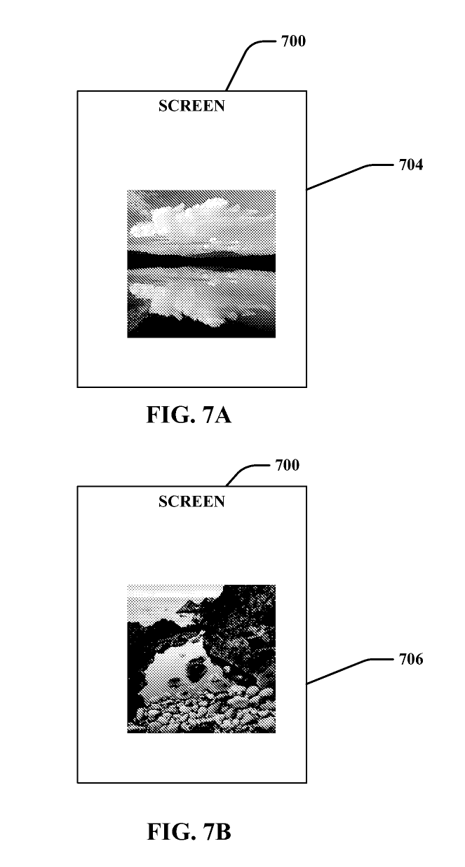

FIGS. 5A, 5B, 6A, 6B, 7A and 7B are illustrations of schematic diagrams of exemplary non-limiting screens for which video compression in a screen-sharing application can be facilitated. In some embodiments, the properties of the display region can include one or more of: movement of a display region from a first location on the screen to a second location on the screen (as shown in FIGS. 6A and 6B), change in content (or content scale) within the display region (as shown in FIGS. 7A and 7B), and/or whether the display region has been re-sized compared to an earlier version of the display region (as shown in FIGS. 5A and 5B).

Turning back to FIG. 2, the resource allocation component 208 can be configured to generate one or more reference buffers. Each reference buffer can correspond to a display region on the screen. As shown in FIG. 4, reference buffers 408, 410, 412, correspond to display regions 402, 406, 406, respectively. As such, the number of reference buffers (and the memory allocated to such) can correspond to the number of display regions.

One or more of the reference buffers can be associated with (or include) identifiers of the one or more display regions. For example, reference buffer 408, which corresponds to display region 402, can include information indicative of an identifier of display region 402. Each reference buffer can also be associated with one or more encoded bitstreams. The encoded bitstreams can include information about the properties of the display region with which the reference buffer corresponds.

The hierarchy component 204 can be configured to determine whether the display regions are located at a particular layer of the screen. The screen can include a number of different layers. The display regions can be configured to be visible on the screen at different layers. For example, display region A 402 is configured to be visible on the screen at a first layer, and display region B 404 is configured to be visible on the screen at a second layer. With reference to FIG. 4, the hierarchy component 204 can be configured to determine that display region A 402 is configured to be visible on screen 400 at a first layer, and display region C 406 (as well as display region B 404) are configured to be visible on the screen at second and third layers. By way of example, but not limitation, the entirety of a screen can be substantially covered with numerous display regions at different layers. In other embodiments, a portion of the screen can be covered with numerous different display regions. All such embodiments are envisaged herein.

Turning back to FIG. 1, the encoder 112 can be configured to encode one or more bitstreams. The manner of encoding can be any number of different types of approaches. By way of example, but not limitation, in some embodiments, as described herein, contents of one or more display regions can be encoded as an Intra frame for the first time that the display region is encoded, or at any point in time thereafter.

Encoded bitstreams can be selectively encoded based on the properties of the display region corresponding to the bitstream. For example, in some embodiments, an encoded bitstream can be generated for each display region configured to be visible on the screen. In some embodiments, an encoded bitstream can be generated for each display region configured to be located at any location on the screen.

In some embodiments, an encoded bitstream can be generated for each display region for which content has changed relative to a previous version of the content of the display region. For example, in some embodiments, the screen analysis component 206 can be configured to determine whether content in a region of interest of a display region at a current time differs from content in the region of interest of the display region at a time earlier than the current time. The encoder 112 can be configured to encode a change in the content in the region of interest between the current time and the time earlier than the current time based, at least, on the screen analysis component 206 determining that the content in the region of interest of the display region at the current time differs from the content in the region of interest of the display region at the time earlier than the current time. For example, the content of display regions 704, 706 of screen 700 (shown in FIGS. 7A and 7B) can be encoded based at least on the change in content over time.

In some embodiments, the encoder 112 can be configured to forego encoding of content of the display region based, at least, on the screen analysis component 206 determining that the content in the region of interest of the display region at the current time fails to differ from the content in the region of interest of the display region at the time earlier than the current time.

In some embodiments, the region of interest is an entirety of the display region. In some embodiments, the region of interest is one or more areas of the display region on which other display regions are non-overlapping (and the region of interest is therefore visible to a user viewing the screen).

In some embodiments, the encoder 112 can be configured to forego encoding information for a display region that is invisible on the screen. For example, the hierarchy component 204 can determine that a display region is invisible on the screen. The encoder 112 can forego encoding such display region. In some embodiments, with pop-up display regions, if the pop-up display region pops up on the screen (e.g., the display region is configured to be visible on the screen), and is a previously-existing display region, and if there is a content change, the change in content can be encoded and transmitted to the receiving device. If there is no change, then only the screen property information needs to be updated and transmitted to the receiving device, while the content itself will not need to be coded or transmitted.

In some embodiments, a display region is moved to a different location while the content of the display region has no change (as shown in FIGS. 6A, 6B). In this embodiment, while the display region position information can be transmitted to the receiving device, no content encoding need be performed.

In another embodiment, the encoder 112 can encode information for the display region, and motion prediction can be performed, associated with re-sizing of the display region. The resource allocation component 208 can be employed to allocate resources for the reference buffer. The encoder 112 can be employed to perform techniques for motion prediction.

By way of example, but not limitation, when a display region is re-sized, motion prediction can be performed as follows. The screen analysis component 206 can determine whether the re-sized content scale for a display region has changed. A change can be identified if the content scale differs from a previous content scale. If the re-sized display region is an interpolated or decimated version of the previous display region, a base reference buffer can be generated employing an interpolated or decimated version of the previous information for the display region. The information associated with the reference buffer can be employed for motion prediction. For example, this method can be performed in embodiments handling encoding and playback of natural video in a display region or in embodiments wherein the fonts in the display region are also re-sized without changing the content layout

In some embodiments, when a display region is re-sized, the displayed content can change due to the changed size of the display region. For example, the re-sized display region can display more content (e.g., display region re-sized from a smaller display region to a larger display region) or less content (e.g., display region re-sized from a larger display region to a smaller display region, as shown in FIGS. 5A and 5B). In these cases, the total existing contents, as well as the location of various elements, of the display region can remain the same notwithstanding the re-sizing as the display region. In these embodiments, the motion prediction can be performed as follows.

If the previous display region is re-sized to a smaller size display region, motion compensation can be employed for the entire reference buffer of information associated with the previous, larger display region. If the previous display region is re-sized to a larger size, then the new, larger display region can be divided into a plurality of segments. For example, the new, larger display region can be divided into two segments. The first segment can be equal to the size of the previous, smaller display region and can be encoded using the previous, smaller display region as a reference. The remaining segment can be encoded as an Intra frame.

For embodiments wherein the display region is re-sized wider horizontally and shorter vertically, or the opposite (less wide horizontally and taller vertically), the overlapped area (e.g., the area present in the previous and the re-sized display regions) can form the first segment, which can be encoded using motion compensation. The remaining segment can be encoded using Intra frame prediction. In some embodiments, if the results of the motion compensation are not satisfactory, the encoder 112 can switch back to encode the first segment using an Intra frame approach.

In other embodiments, when size and/or location of the existing contents in the display region are changed upon re-sizing the display region, the encoder can employ an Intra frame encoding approach for encoding the re-sized display region.

Microprocessor 210 can perform one or more of the functions described herein with reference to any of the systems and/or methods disclosed. The memory 212 can be a computer-readable storage medium storing computer-executable instructions and/or information for performing the functions described herein with reference to any of the systems and/or methods disclosed.

Turning back to FIG. 1, the compression component 114 can be configured to perform video compression. In various embodiments, as described herein, video compression can be performed on contents of one or more display regions in instances in which the contents change over time, for example. The compression can be performed employing H.264, VP8 and/or any of a number of other types of compression.

The decompression component 124 can be configured to decompress the information received at the decoder system 118, and the decoder 122 can be configured to decode the encoded bitstream.

In some embodiments, the decoder system 118 of system 100 can include the decoder management component 120′ shown in FIG. 3. In some embodiments, the decoder management component 120′ can include a communication component 302, a screen analysis component 304, a resource allocation component 306, a rendering component 308, a microprocessor 310 and/or a memory 312. The communication component 302, screen analysis component 304, resource allocation component 306, rendering component 308, microprocessor 310 and/or memory 312 can be electrically and/or communicatively coupled to one another to perform one or more of the functions of the decoder management component 120′.

The communication component 302 can be configured to transmit and/or receive information to or from a user terminal 126 configured to display video information, or to or from the encoder system 108.

The resource allocation component 306 can be configured to receive one or more reference buffers associated with one or more display regions. The resource allocation component 306 can separately analyze the reference buffer for each display region. In some embodiments, the resource allocation component 306 can be configured to delete a resource buffer (and/or delete resources) dedicated to a deleted display region.

In some embodiments, the screen analysis component 304 can be configured to determine the properties of the screen and/or the display regions to be displayed on the screen. Accordingly, the screen analysis component 304 can determine, from the decoded bitstream, information such as whether content of a display region has changed, whether a display region has been re-sized or moved, layer information associated with one or more display regions or the like. In various embodiments, the screen analysis component 304 can determine, from the decoded bitstream, the location of the display region (e.g., whether a display region is configured to be visible or invisible on the screen).

In various embodiments, the display regions can be rendered by the rendering component 308.

Microprocessor 310 can perform one or more of the functions described herein with reference to any of the systems and/or methods disclosed. The memory 312 can be a computer-readable storage medium storing computer-executable instructions and/or information for performing the functions described herein with reference to any of the systems and/or methods disclosed.

Another embodiment of a system 100 can be as follows. The communication component 202 can be configured to transmit and/or receive information from the user terminal 102 and/or a communication channel coupling the encoder system 108 and the decoder system 118. In some embodiments, the communication component 202 can be configured to receive video information from a camera or other device configured to capture images of video (or images configured to be displayed as video). For example, the communication component 202 can receive such information from a camera communicatively coupled to a laptop or other device recording a presentation. By way of example, but not limitation, the communication component 202 can receive information indicative of images of a presentation during a web conference, or screencasting information.

In various embodiments, the communication component 202 can be configured to receive a first stream of video information configured for display at a first display region of a screen. The communication component 202 can also be configured to receive a second stream of video information configured for display at a second display region of the screen. In some embodiments, the first stream of video information and the second stream of video information can originate from two different sources. The sources may be located in different geographical areas, for example. In other embodiments, the sources of the first stream and the second stream are the same.

The screen analysis component 206 can be configured to determine one or more properties of the screen, and/or determine one or more properties of the first display region and the second display region.

The hierarchy component 204 can be configured to rank the first display region and the second display region. The ranking can be based on whether the first display region and/or the second display region is configured to be visible on the screen. For example, the display region configured to be visible on the screen can be determined to be a high ranked display region. In some embodiments, if the first display region and the second display region are non-overlapping for example, both display regions can be determined to be configured to be visible on the screen, and can be high ranking display regions.

The encoder 112 can be configured to generate an encoded bitstream for the one or more high ranked display regions. The encoded bitstream can include information indicative of the properties of the high ranked display region.

The resource allocation component 208 can be configured to generate reference buffers for the first display region and the second display region. The reference buffers can be associated with identifiers of the first display region and the second display region. One of the reference buffers can be associated with the high ranked display region, and include the encoded bitstream for the high ranked display region. In some embodiments, the resource allocation component 208 can also be configured to delete the reference buffer for the first display region or the second display region based, at least, on the communication component 202 receiving or obtaining information indicative of the first display region or the second display region being deleted. Such information can be obtained based on inputs at the user interface 104, for example. In some embodiments, the system can also include a decoder 122 configured to decode the encoded bitstream associated with the reference buffer for the high ranked display region. The system can also include a screen analysis component 304 configured to determine one or more properties of the screen or the high ranked display region. The system can also include a rendering component 308 configured to display the high ranked display region configured to be visible on the screen, displaying being based, at least, on the one or more properties.

Accordingly, embodiments herein can reduce the amount of information for video compression and correspondingly reduce the information transmitted to the receiving device. As such, bandwidth utilization and processing power can be reduced.

In embodiments described herein, the encoded bitstream can be associated with a syntax composed of one or more components. For example, an ADOBE™ bitstream syntax can be employed in some embodiments.

The encoded bitstream syntax can be composed of cursor location and shape encoding, display region list and descriptions of the display regions (e.g., ID associated with each display region and display region properties), and/or display region encoding.

The bitstream syntax can include, but is not limited to, one or more of the following: picture header, version number, time code, cursor encoding, display region property (e.g., display region ID, display region start position, display region size, display region overlay layer and/or an indication of whether there is content change within the display region), and/or bitstream indication.

In some embodiments, the picture header can be an identifier to identify the bitstream start position. An 8-bit unicode of “G” can be employed.

The version number can identify the versions of the design described herein. The initial value can be 0001 (to indicate version 1.0). Other values can be reserved for future version numbers.

The time code can represent the time of the encoded content. The time can be indicated in increments of one millisecond in some embodiments. The time can be represented with a modulo operation of 2¹⁶, which can represent approximately 65 seconds worth of time. In order to reduce the chance of a wraparound problem, one encoded bitstream can be transmitted at approximately every 32 seconds. A difference between two consecutive time codes can represent the time difference between the encoding of the two sets of content.

Cursor or mouse movement encoding can be included in a field for every encoded bitstream. For example, the cursor can be encoded by an 8-bit shape encoding field plus two 12-bit location fields for cursor location.

The number of display regions on the screen can be indicated by 10 bits in some embodiments. Accordingly, a total of 1024 display regions can be represented.

The display region properties can be represented in a variable length field. The window property can include display region identification (ID), display region start position, display region size, display region overlay layer, and/or an indication of whether there is content change within the display region. In some embodiments, the display region ID can be a variable length field filled with a variable length tree-structured code to represent an offset of the display region ID from the previous display region ID. The offset of the first display region ID can be relative to zero. For example, if display region numbers 1, 2, 6 are in the display region list to be encoded, such display regions can be encoded according to the following offsets: 1−0=1; 2−1=1; and 6−2=4. In one variable length representation, they can be expressed as the following (in bits): 1100100.

The display region start position and display region size can be indicated by a variable length field. The field can include variable length code of values “0”, “10”, “110” or “111”, which can be used to indicate the following: 0: the display region start position and size remain unchanged (accordingly, no more information is carried after this field); 10: the display region size is changed, but start position remains unchanged (two 12-bit fields can then follow to indicate the display region horizontal and vertical sizes); 110: the display region size is unchanged and the start position changed (two 12-bit fields can then follow to indicate the display region start position); and 111: the display region size and start position both changed (two 12-bit fields can indicate the display region size followed by another two 12-bit fields to indicate the display region start position).

The overlay layer indication can control the display/render of the visible display regions at the user terminal associated with displaying the video information. The following variable length codes can be used to carry this information: 0: the overlay layer information for the display regions has no change; 10: the overlay layer indicates that a display region is popped to the top layer (layer 0), the order of the other layer for the display regions has no change. Therefore, the display regions with a layer lower than the display region being popped to the top layer can be pushed down (layer number increased by one), while layer numbers for all other display regions can remain unchanged. If the display region being popped to the top layer is a new display region or a display region that is newly-opened (and was previously closed, as identified by the display region ID), then all other display regions' overlay layer numbers can be increased by one.

The overlay layer of 110 can indicate that the display region is being deleted. All display regions with a layer behind this display region can be popped up by one, while the display regions in front of this display region can remain unchanged. Upon receipt of this overlay information, the decoder 122 can remove all the resources for this display region.

The overlay layer of 111 can indicate the display region is being closed, all display regions with a layer number behind this display region can be popped up by one, while the display regions in front of this display region can remain unchanged. The decoder 122 can keep all the resources (including the reference buffers) relevant to this display region for possible use in the future, if the display region is re-opened.

The bitstream indication can be a bit to indicate whether or not display region contents are encoded in a following bitstream. Each display region can have an associated bitstream indication for the display region content. A value of 1 can indicate that the display region content is encoded, and the compressed bitstream follows. A value of 0 can indicate that the display region content is not encoded, and no compressed bitstream follows. The encoder can decide when to encode a display region as described herein.

At the decoder system 118, the decoder 122 can be configured to decode bitstream syntax to cause updating of information associated with one or more reference buffers associated with the decoder system 118.

While the foregoing described certain embodiments employing display region-based multi-reference buffer encoding, decoding and display region properties, modifications are possible and are envisaged. By way of example, but not limitation, in some embodiments, the mouse movement can be encoded into the encoded bitstream. By way of another example, the re-sized display region can be encoded in a manner different from that described. As another example, the design of the bitstream syntax can be different from that described.

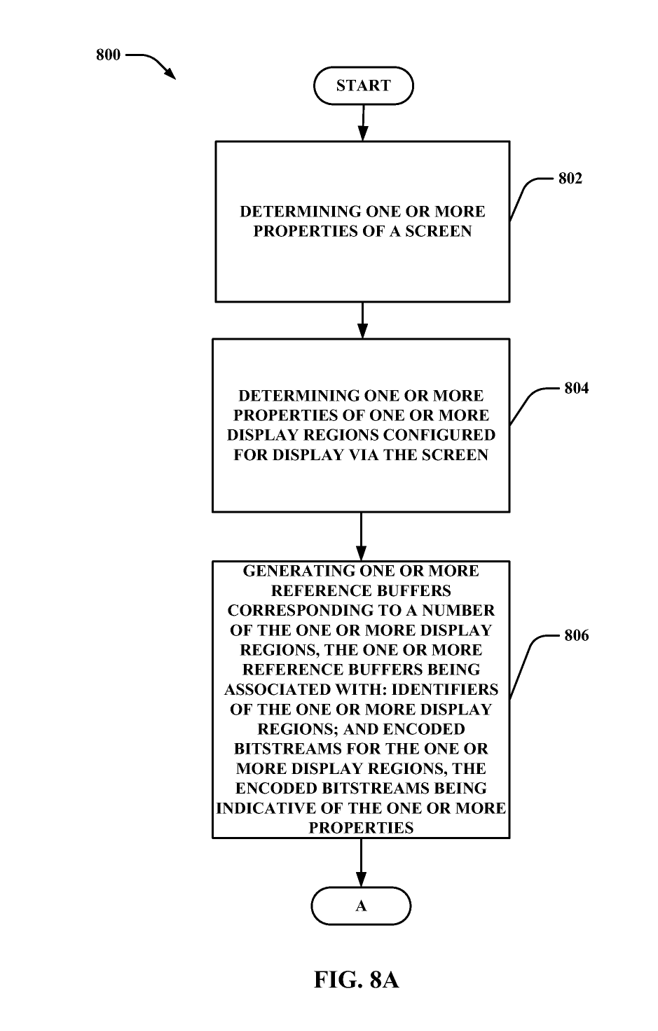

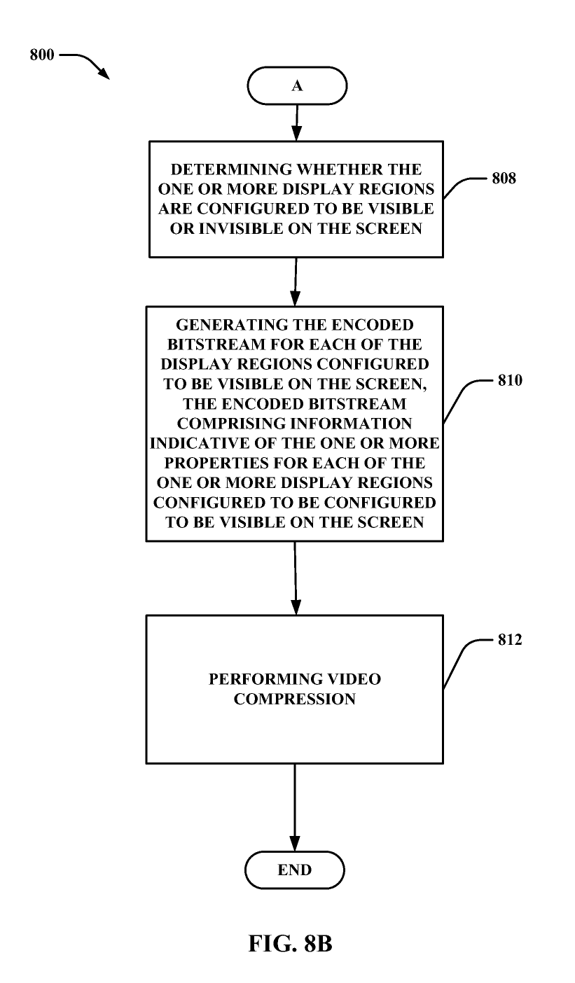

FIGS. 8A, 8B, 9, 10 and 11 are illustrations of exemplary flow diagrams of methods for facilitating video compression in a screen-sharing application.

Turning first to FIGS. 8A and 8B, at 802, method 800 can include determining one or more properties of a screen (e.g., by the screen analysis component 206). The screen can be a personal computer (PC) screen in some embodiments. In other embodiments, the screen can include, but is not limited to, a tablet screen, a laptop screen or a mobile telephone screen.

In some embodiments, the properties of the screen can include, but are not limited to: a number of display regions configured for display via the screen, sizes of the display regions, layer information for the one or more display regions, identities of the display regions configured to be visible on the screen, identities of the display regions configured to be invisible on the screen, information indicating whether content of the display regions is active or static, identities of display regions that are open or identities of display regions that are minimized. In some embodiments, determining the one or more properties of the screen can include, but is not limited to, detecting a pop-up of one of the display regions.

At 804, method 800 can include determining one or more properties of one or more display regions configured for display via the screen (e.g., by the screen analysis component 206). In some embodiments, the properties can include one or more of: movement of the display region, change in content (or content scale) within the display region and/or whether the display region has been re-sized compared to an earlier version of the display region.

At 806, method 800 can include generating one or more reference buffers corresponding to the number of display regions (e.g., by the resource allocation component 208). The reference buffers can be associated with identifiers of the display regions, and encoded bitstreams for the display regions. By way of example, but not limitation, each reference buffer can correspond to a display region. For example, with reference to FIG. 4, reference buffer A 408 can correspond to display region A 402, reference buffer B 410 can correspond to display region B 404 and reference buffer C 412 can correspond to display region C 406.

A reference buffer can be created based on the creation of a display region. Correspondingly, when a display region is deleted, the reference buffer for the display region can be deleted. As such, memory associated with a reference buffer can be conserved.

At 808, method 800 can include determining whether the one or more display regions are configured to be visible or invisible on the screen (e.g., by the hierarchy component 204).

At 810, method 800 can include generating the encoded bitstream for each of the display regions configured to be visible on the screen (e.g., by the encoder 112). The encoded bitstream can include information indicative of the one or more properties for each of the one or more display regions configured to be visible on the screen.

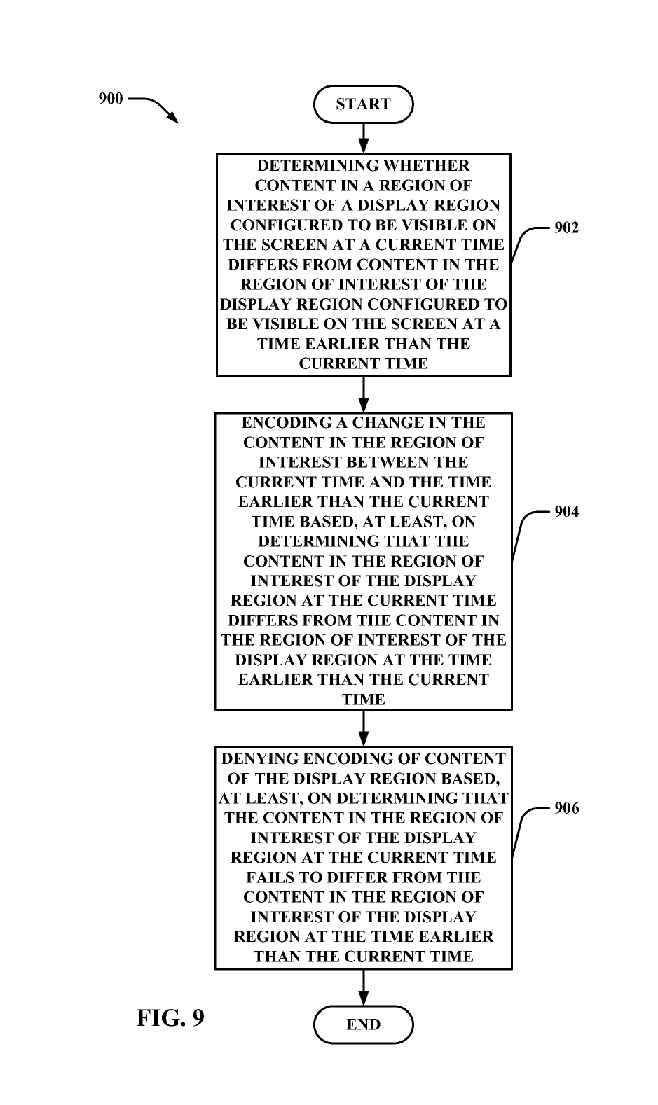

Turning to FIG. 9, in some embodiments, generating an encoded bitstream, e.g., at 810, can include 902, 904 and/or 906. At 902, method 900 can include determining whether content in a region of interest of a display region configured to be visible on the screen at a current time differs from content in the region of interest of the display region configured to be visible on the screen at a time earlier than the current time (e.g., by the screen analysis component 206). In some embodiments, the region of interest is the entire display region. However, in other embodiments, the region of interest is one or more areas of the display region on which other ones of the plurality of display regions are non-overlapping. For example, with reference to FIG. 4, the region of interest for display region B 404 can include the region that is not overlapped by display region A 402, and that is therefore visible to a user viewing the screen 400. As such, the embodiments disclosed herein can limit processing to the portions of the display region visible to a viewer of the screen, thereby reducing a number of bits transmitted to a receiving device, and/or reducing processing power at the transmitting device (e.g., encoder management component 110′) and at the receiving device (e.g., decoder management component 120′).

At 904, method 900 can include encoding a change in the content in the region of interest between the current time and the time earlier than the current time (e.g., by the encoder 112). The encoding can be based, at least, on determining that the content in the region of interest of the display region at the current time differs from the content in the region of interest of the display region at the time earlier than the current time (e.g., by the screen analysis component 206).

At 906, method 900 can include denying (e.g., rejecting or bypassing) encoding of content of the display region (e.g., by the encoder 112). The encoding can be based, at least, on determining that the content in the region of interest of the display region at the current time fails to differ from the content in the region of interest of the display region at the time earlier than the current time (e.g., by the screen analysis component 206).

In some embodiments, (although now shown) method 900 can include denying encoding a change in content in a region of interest of a display region (e.g., by the encoder 112). The denying encoding can be based at least, on determining that the display region is configured to be invisible on the screen (e.g., by the screen analysis component 206). In various embodiments, a display region can be configured to be invisible on the screen if no portion of the display region is visible on the screen.

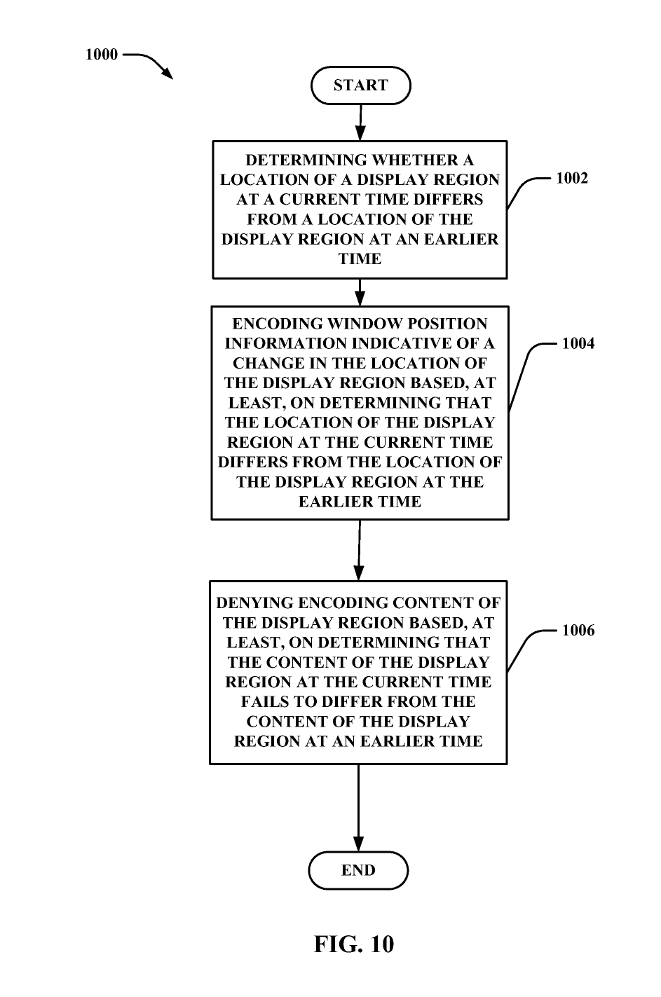

Turning to FIG. 10, in some embodiments, generating an encoded bitstream, e.g., at 810, can include 1002, 1004 and 1006. At 1002, method 1000 can include determining whether a location of a display region at a current time differs from a location of the display region at an earlier time (e.g., by the screen analysis component 206). At 1004, method 1000 can include encoding display region position information indicative of a change in the location of the display region (e.g., by the encoder 112). The encoding can be based, at least, on determining that the location of the display region at the current time differs from the location of the display region at the earlier time (e.g., by the screen analysis component 206). In some embodiments, at 1006, method 1000 can include denying (e.g., rejecting or bypassing) encoding of content of the display region e.g., (by the encoder 112). The denial can be based, at least, on determining that the content of the display region at the current time fails to differ from the content of the display region at an earlier time (e.g., by the screen analysis component 206).

In some embodiments, generating the encoded bitstream can include determining that content of the display region at a current time is an interpolated or decimated version of content of the display region at an earlier time (e.g., by the screen analysis component 206). In some embodiments, generating the encoded bitstream can also include generating prediction information by applying a corresponding interpolation or decimation to content of the display region at the earlier time (e.g., by a motion prediction component (not shown)).

In some embodiments, generating the encoded bitstream can include: determining that a size of a display region at a current time differs from a size of a display region at an earlier time (e.g., by the screen analysis component 206). Generating the encoded bitstream can also include determining that a total content of the display region at the current time differs from content of the display region at the earlier time, wherein subject matter of the content of the display region at the earlier time is a same size and in a same location as corresponding subject matter of the content of the display region at the current time (e.g., by the screen analysis component 206).

Turning back to FIG. 8B, at 812, method 800 can include performing video compression (e.g., by the compression component 114).

In some embodiments, method 800 can include encoding a location and a shape of a cursor associated with the screen (e.g., by the encoder 112). In some embodiments, the location and shape of the cursor is always transmitted to the receiving device.

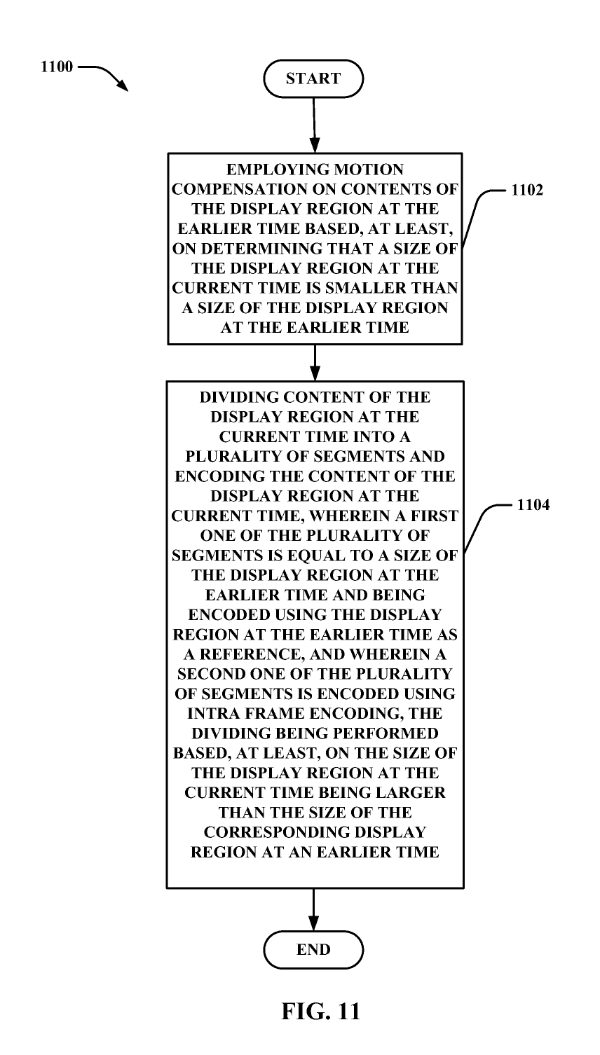

Turning to FIG. 11, in some embodiments, as shown, methods of facilitating video compression in screen-sharing applications, can also include motion compensation. For example, at 1102, method 1100 can include employing motion compensation on contents of the display region at the earlier time (e.g., by a motion compensation component (not shown)). Applying the motion compensation can be based, at least, on determining that a size of the display region at the current time is smaller than a size of the display region at the earlier time (e.g., by the screen analysis component 206). At 1104, method 1100 can include dividing content of the display region at the current time into a plurality of segments and encoding the content of the display region at the current time (e.g., by a motion compensation component (not shown)). Dividing the content can be performed based, at least, on the size of the display region at the current time being larger than the size of the corresponding display region at an earlier time. A first segment can be equal to a size of the display region at the earlier time and being encoded using the display region at the earlier time as a reference. A second segment can be encoded using Intra frame encoding (e.g., by the encoder 112).

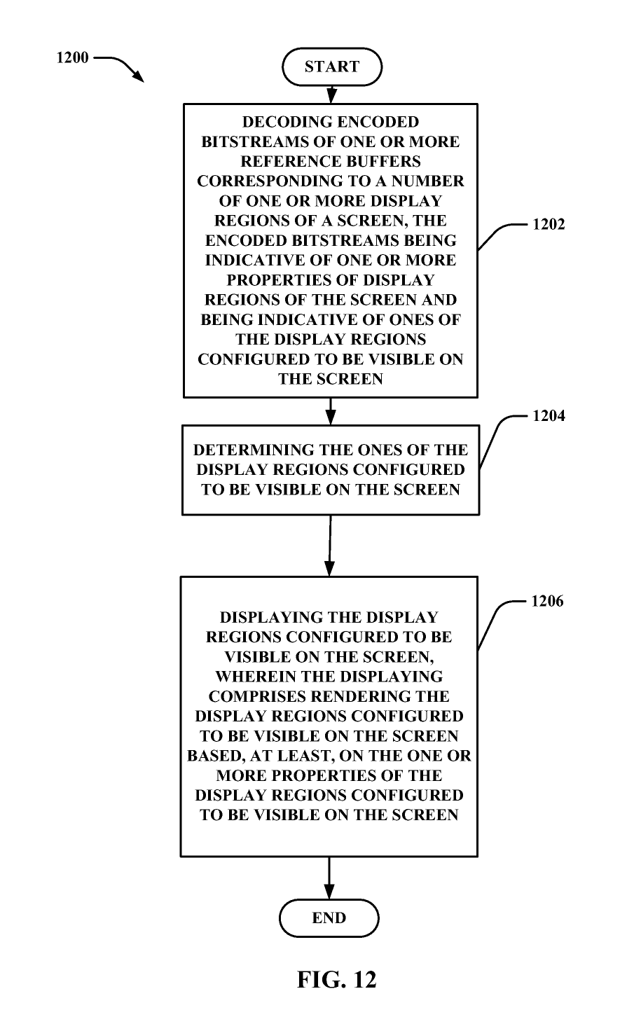

FIG. 12 is an illustration of an exemplary flow diagram of method for facilitating video decompression in a screen-sharing application. At 1202, method 1200 can include decoding encoded bitstreams of one or more reference buffers (e.g., by the decoder 122). The one or more reference buffers can correspond to a number of one or more display regions of a screen. The encoded bitstreams can be indicative of one or more properties of display regions of the screen. The encoded bitstreams can also be indicative of display regions configured to be visible on the screen.

At 1204, method 1200 can include determining the ones of the display regions configured to be visible on the screen (e.g., by the screen analysis component 304). At 1206, method 1200 can include displaying the display regions configured to be visible on the screen (e.g., by the rendering component 308). In some embodiments, displaying can include rendering the display regions configured to be visible on the screen.

When new display regions are created on the screen, new reference buffers can be generated that correspond to the new reference buffers (e.g., by the resource allocation component 306). When a display region is deleted, the corresponding reference buffer can be deleted (e.g., by the resource allocation component 306). The sizes of the reference buffers can vary depending on the size of the display region to which the reference buffer corresponds.

The embodiments described herein can be employed in or be included as part of web conferencing and/or screencasting systems and/or methods. Screencasting can include, but is not limited to, a recording of a video screen output (which may or may not include capturing audio associated with a computer screen). The screencast can include one or more changes in the computer screen output over time as seen by a viewer of the computer screen to which the video is output.

### Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

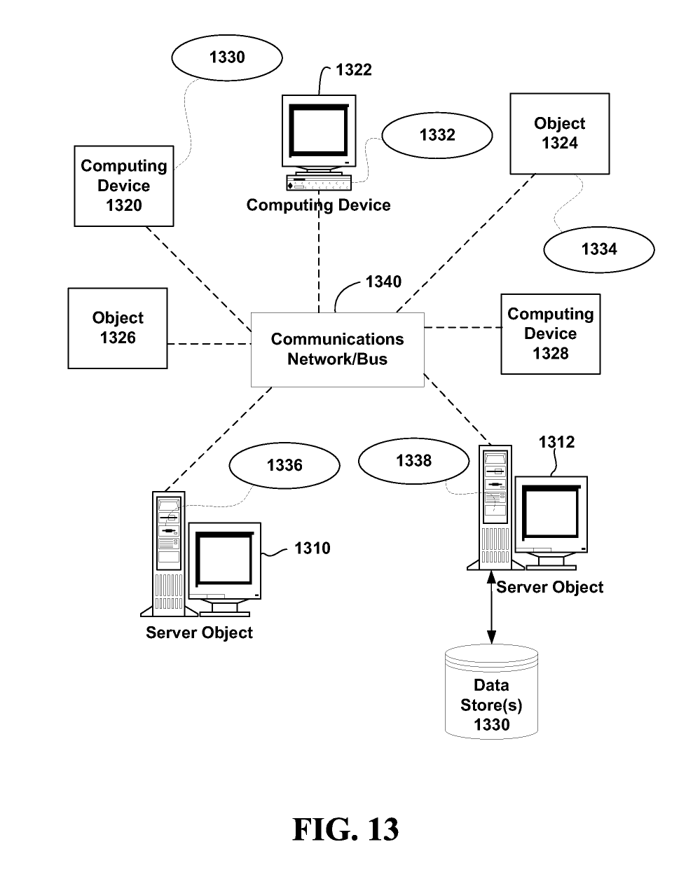

FIG. 13 provides a schematic diagram of an exemplary networked or distributed computing environment in which embodiments described herein can be implemented. The distributed computing environment includes computing objects 1310, 1312, etc. and computing objects or devices 1320, 1322, 1324, 1326, 1328, etc., which can include programs, methods, data stores, programmable logic, etc., as represented by applications 1330, 1332, 1334, 1336, 1338. It can be appreciated that computing objects 1310, 1312, etc. and computing objects or devices 1320, 1322, 1324, 1326, 1328, etc. can include different devices, such as personal digital assistants (PDAs), audio/video devices, mobile phones, MPEG-1 Audio Layer 3 (MP3) players, personal computers, laptops, tablets, etc.

Each computing object 1310, 1312, etc. and computing objects or devices 1320, 1322, 1324, 1326, 1328, etc. can communicate with one or more other computing objects 1310, 1312, etc. and computing objects or devices 1320, 1322, 1324, 1326, 1328, etc. by way of the communications network 1340, either directly or indirectly. Even though illustrated as a single element in FIG. 13, communications network 1340 can include other computing objects and computing devices that provide services to the system of FIG. 13, and/or can represent multiple interconnected networks, which are not shown. Each computing object 1310, 1312, etc. or computing objects or devices 1320, 1322, 1324, 1326, 1328, etc. can also contain an application, such as applications 1330, 1332, 1334, 1336, 1338, that might make use of an application programming interface (API), or other object, software, firmware and/or hardware, suitable for communication with or implementation of the various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The client can be a member of a class or group that uses the services of another class or group. A client can be a computer process, e.g., roughly a set of instructions or tasks, that requests a service provided by another program or process. A client can utilize the requested service without having to know all working details about the other program or the service itself.

As used in this application, the terms “component,” “module,” “system,” and the like are intended to refer to a computer-related entity, either hardware, software, firmware, a combination of hardware and software, software and/or software in execution. For example, a component can be, but is not limited to being, a process running on a processor, a processor, an object, an executable, a thread of execution, a program, and/or a computer. By way of illustration, both an application running on a computing device and/or the computing device can be a component. One or more components can reside within a process and/or thread of execution and a component can be localized on one computer and/or distributed between two or more computers. In addition, these components can execute from various computer-readable storage media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

In a client/server architecture, particularly a networked system, a client can be a computer that accesses shared network resources provided by another computer, e.g., a server. In the illustration of FIG. 13, as a non-limiting example, computing objects or devices 1320, 1322, 1324, 1326, 1328, etc. can be thought of as clients and computing objects 1310, 1312, etc. can be thought of as servers where computing objects 1310, 1312, etc. provide data services, such as receiving data from client computing objects or devices 1320, 1322, 1324, 1326, 1328, etc., storing of data, processing of data, transmitting data to client computing objects or devices 1320, 1322, 1324, 1326, 1328, etc., although any computer can be considered a client, a server, or both, depending on the circumstances. Any of these computing devices can process data, or request transaction services or tasks that can implicate the techniques for systems as described herein for one or more embodiments.

A server can be typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 1340 can be the Internet, for example, the computing objects 1310, 1312, etc. can be Web servers, file servers, media servers, etc. with which the client computing objects or devices 1320, 1322, 1324, 1326, 1328, etc. communicate via any of a number of known protocols, such as the hypertext transfer protocol (HTTP). Computing objects 1310, 1312, etc. can also serve as client computing objects or devices 1320, 1322, 1324, 1326, 1328, etc., as can be characteristic of a distributed computing environment.

### Exemplary Computing Device

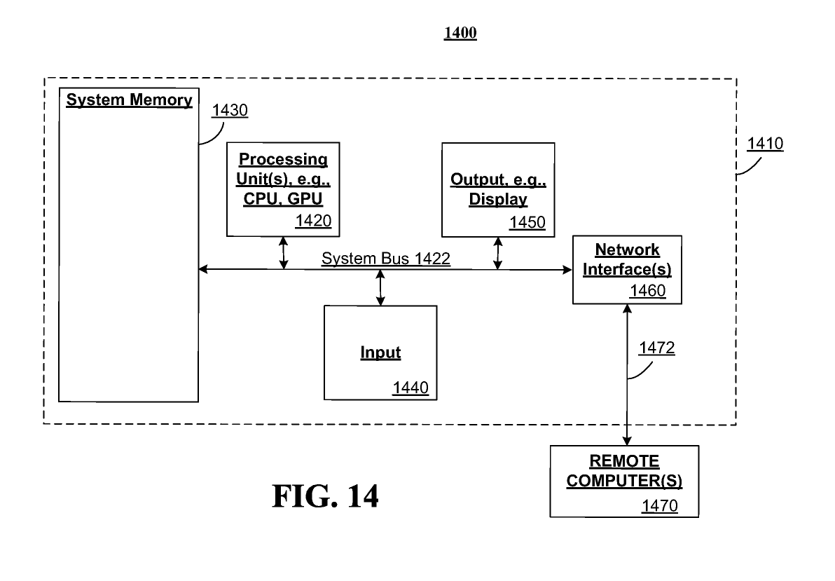

As mentioned, advantageously, the techniques described herein can be applied to any suitable device. It is to be understood, therefore, that handheld, portable and other computing devices and computing objects of all kinds are contemplated for use in connection with the various embodiments, i.e., anywhere that a device may wish to read or write transactions from or to a data store. Accordingly, the below remote computer described below in FIG. 14 is but one example of a computing device. Additionally, a suitable server can include one or more aspects of the below computer, such as a media server or other media management server components.

Although not required, embodiments can be partly implemented via an operating system, for use by a developer of services for a device or object, and/or included within application software that operates to perform one or more functional aspects of the various embodiments described herein. Software can be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 14 thus illustrates an example of a suitable computing environment 1400 in which one or aspects of the embodiments described herein can be implemented, although as made clear above, the computing environment 1400 is only one example of a suitable computing environment and is not intended to suggest any limitation as to scope of use or functionality. Neither is the computing environment 1400 to be interpreted as having any dependency or requirement relating to any one or combination of components illustrated in the exemplary computing environment 1400.

With reference to FIG. 14, an exemplary computing environment 1400 for implementing one or more embodiments includes a computing device in the form of a computer 1410 is provided. Components of computer 1410 can include, but are not limited to, a processing unit 1420, a memory 1430, and a system bus 1422 that couples various system components including the system memory to the processing unit 1420.

Computer 1410 typically includes a variety of computer readable media and can be any available media that can be accessed by computer 1410. The memory 1430 can include computer storage media in the form of volatile and/or nonvolatile memory such as read only memory (ROM) and/or random access memory (RAM). By way of example, and not limitation, memory 1430 can also include an operating system, application programs, other program modules, and program data.

A user can enter commands and information into the computer 1410 through input devices 1440, non-limiting examples of which can include a keyboard, keypad, a pointing device, a mouse, stylus, touchpad, touch screen, trackball, motion detector, camera, microphone, joystick, game pad, scanner, video camera or any other device that allows the user to interact with the computer 1410. A monitor or other type of display device can be also connected to the system bus 1422 via an interface, such as output interface 1450. In addition to a monitor, computers can also include other peripheral output devices such as speakers and a printer, which can be connected through output interface 1450.

The computer 1410 can operate in a networked or distributed environment using logical connections to one or more other remote computers, such as remote computer 1470. The remote computer 1470 can be a personal computer, a server, a router, a network PC, a peer device or other common network node, or any other remote media consumption or transmission device, and can include any or all of the elements described above relative to the computer 1410. The logical connections depicted in FIG. 14 include a network 1472, such local area network (LAN) or a wide area network (WAN), but can also include other networks/buses e.g., cellular networks.

As mentioned above, while exemplary embodiments have been described in connection with various computing devices and network architectures, the underlying concepts can be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques detailed herein. Thus, embodiments herein are contemplated from the standpoint of an API (or other software object), as well as from a software or hardware object that implements one or more aspects described herein. Thus, various embodiments described herein can have aspects that are wholly in hardware, partly in hardware and partly in software, as well as in software.

Computing devices typically include a variety of media, which can include computer-readable storage media and/or communications media, in which these two terms are used herein differently from one another as follows. Computer-readable storage media can be any available storage media that can be accessed by the computer, can be typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, electrically erasable programmable read only memory (EEPROM), flash memory or other memory technology, compact disc read only memory (CD-ROM), digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal (e.g., a carrier wave or other transport mechanism) and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, radio frequency (RF), infrared and other wireless media.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors and/or other electronic units designed to perform the functions described herein, or a combination thereof.

When the embodiments are implemented in software, firmware, middleware or microcode, program code or code segments, they can be stored in a machine-readable medium (or a computer-readable storage medium), such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules or components (e.g., procedures, functions, and so on) that perform the functions described herein. The software codes can be stored in memory units and executed by processors. A memory unit can be implemented within the processor or external to the processor, in which case it can be communicatively coupled to the processor via various structures.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components can be combined into a single component providing aggregate functionality or divided into several separate sub-components, and that any one or more middle layers, such as a management layer, can be provided to communicatively couple to such sub-components in order to provide integrated functionality. Any components described herein can also interact with one or more other components not specifically described herein but generally known by those of skill in the art.

In view of the exemplary systems described above methodologies that can be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks can be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. The invention is not to be limited to any single embodiment, but rather can be construed in breadth, spirit and scope in accordance with the appended claims.

What is claimed is:

1. A method for facilitating video compression in a screen-sharing application, comprising:
employing a microprocessor to execute computer executable components stored within a memory to perform the following:
determining one or more properties of a screen;
determining one or more properties of one or more display regions configured for display via the screen;
generating one or more reference buffers corresponding to a number of the one or more display regions, the one or more reference buffers being associated with:
identifiers of the one or more display regions; and
encoded bitstreams for the one or more display regions, the encoded bitstreams being indicative of the one or more properties of the one or more display regions;
determining whether the one or more display regions are configured to be visible or invisible on the screen; and
generating the encoded bitstreams for the one or more display regions configured to be visible on the screen, the encoded bitstreams comprising information indicative of the one or more properties for the one or more display regions configured to be visible on the screen.

2. The method of claim 1, further comprising performing video compression.

3. The method of claim 1, wherein the one or more properties of the screen comprises at least one of: a number of the one or more display regions configured for display via the screen, sizes of the one or more display regions configured for display via the screen, identities of the one or more display regions configured to be visible on the screen, identities of the one or more display regions configured to be invisible on the screen, whether content of the one or more display regions is active or static, identities of the one or more display regions that are open or identities of the one or more display regions that are minimized.

4. The method of claim 1, wherein the one or more properties comprises at least one of: movement of the one or more display regions, content within the one or more display regions or change in content within the one or more display regions or re-sizing of the one or more display regions.

5. The method of claim 1, wherein the generating the encoded bitstreams further comprises:
determining whether content in a region of interest of a display region configured to be visible on the screen at a current time differs from content in the region of interest of the display region configured to be visible on the screen at a time earlier than the current time;
encoding a change in the content in the region of interest between the current time and the time earlier than the current time based, at least, on determining that the content in the region of interest of the display region at the current time differs from the content in the region of interest of the display region at the time earlier than the current time; and
denying encoding of content of the display region based, at least, on determining that the content in the region of interest of the display region at the current time fails to differ from the content in the region of interest of the display region at the time earlier than the current time.

6. The method of claim 5, wherein the region of interest is an entirety of the display region.

7. The method of claim 5, wherein the region of interest is one or more areas of the one or more display regions on which other ones of the one or more display regions are non-overlapping.

8. The method of claim 1, further comprising denying encoding a change in content in a region of interest of a display region, based at least, on determining that the display region is configured to be invisible on the screen.

9. The method of claim 1, wherein at least one of the one or more display regions configured to be visible on the screen is a pop-up display region.

10. The method of claim 1, wherein the determining the one or more properties of the screen comprises: detecting a pop-up of a one of the one or more display regions, the detecting comprising detecting the one of the one or more display regions configured to be visible on the screen at a current time and a same one of the one or more display regions configured to be invisible on the screen at a time earlier than the current time.

11. The method of claim 1, further comprising encoding a location and a shape of a cursor associated with the screen.

12. The method of claim 1, wherein the screen is at least one of a personal computer screen, a laptop screen, a tablet screen or a mobile telephone screen.

13. The method of claim 1, wherein the encoded bitstreams comprise one or more bits indicative of at least one of: a number of the one or more display regions, whether the one or more display regions are open or closed or whether content displayed via the one or more display regions is active or static.

14. The method of claim 1, wherein the encoded bitstreams comprise one or more bits indicative of at least one of: cursor movement in the one or more display regions, respective sizes of the one or more display regions or respective positions of the one or more display regions.

15. The method of claim 1, further comprising deleting a one of the one or more reference buffers based, at least, on determining that a corresponding one of the one or more display regions is deleted.

16. The method of claim 1, wherein the generating the encoded bitstreams further comprises:
determining whether a location of a display region configured to be visible on the screen at a current time differs from a location of the display region at an earlier time; and
encoding display region position information indicative of a change in the location of the display region based, at least, on determining that the location of the display region at the current time differs from the location of the display region at the earlier time.

17. The method of claim 16, further comprising:
denying encoding content of the display region based, at least, on determining that the content of the display region at the current time fails to differ from the content of the display region at an earlier time.

18. The method of claim 1, wherein the generating the encoded bitstreams further comprises:
determining that content of the one or more display regions configured to be visible on the screen at a current time is an interpolated or decimated version of content of a same one of the one or more display regions at an earlier time; and
generating prediction information by applying a corresponding interpolation or decimation to content of the one or more display regions at the earlier time.

19. The method of claim 1, wherein the generating the encoded bitstreams further comprises:
determining that a size of a display region configured to be visible on the screen at a current time differs from a size of the display region at an earlier time; and
determining that a total content of the display region at the current time differs from content of the display region at the earlier time, wherein subject matter of the content of the display region at the earlier time is a same size and in a same location as corresponding subject matter of the content of the display region at the current time.

20. The method of claim 19, further comprising:
employing motion compensation on contents of the display region at the earlier time based, at least, on determining that a size of the display region at the current time is smaller than a size of the display region at the earlier time; and
dividing content of the display region at the current time into a plurality of segments and encoding the content of the display region at the current time,
wherein a first one of the plurality of segments is equal to a size of the display region at the earlier time and being encoded using the display region at the earlier time as a reference, and
wherein a second one of the plurality of segments is encoded using Intra frame encoding, the dividing being performed based, at least, on the size of the display region at the current time being larger than the size of a corresponding one of one or more display regions at an earlier time.

21. A system configured to facilitate video compression in a screen-sharing application, comprising:
a memory that stores computer executable components; and
a microprocessor that executes the following computer executable components stored in the memory:
a screen analysis component configured to:
determine one or more properties of a screen; and
determine one or more properties of one or more display regions configured for display via the screen;
a resource allocation component configured to generate one or more reference buffers corresponding to a number of the one or more display regions, the one or more reference buffers being associated with:
identifiers of the one or more display regions; and
encoded bitstreams for the one or more display regions, the encoded bitstreams being indicative of the one or more properties;
a hierarchy component configured to determine whether the one or more display regions are configured to be visible or invisible on the screen;
an encoder configured to generate the encoded bitstreams for the one or more display regions configured to be visible on the screen, the encoded bitstreams comprising information indicative of the one or more properties of the one or more display regions configured to be visible on the screen; and
a compression component configured to perform video compression.

22. The system of claim 21, wherein the one or more properties of the screen comprises at least one of: a number of the one or more display regions configured for display via the screen, sizes of the one or more display regions configured for display via the screen, identities of the one or more display regions configured to be visible on the screen, identities of the one or more display regions configured to be invisible on the screen, whether content of the one or more display regions are active or static, identities of the one or more display regions that are open or identities of the one or more display regions that are minimized.

23. The system of claim 21, wherein the one or more properties comprises at least one of: movement of the one or more display regions, content within the one or more display regions or change in content within the one or more display regions, a change in content being a change between a current time and a time prior to the current time within one or more display regions.

24. The system of claim 21, wherein generating the encoded bitstreams further comprises:
determining whether content in a region of interest of a display region configured to be visible on the screen at a current time differs from content in the region of interest of the display region configured to be visible on the screen at a time earlier than the current time;
encoding a change in the content in the region of interest between the current time and the time earlier than the current time based, at least, on determining that the content in the region of interest of the display region at the current time differs from the content in the region of interest of the display region at the time earlier than the current time; and
denying encoding of content of the display region based, at least, on determining that the content in the region of interest of the display region at the current time fails to differ from the content in the region of interest of the display region at the time earlier than the current time.

25. The system of claim 24, wherein the region of interest is an entirety of the display region.

26. The system of claim 24, wherein the region of interest is one or more areas of the one or more display regions on which other ones of the one or more display regions are non-overlapping.

27. The system of claim 21, wherein the encoder is further configured to deny encoding a change in content in a region of interest of a display region, based at least, on the screen analysis component determining that the display region configured to be invisible on the screen.

28. The system of claim 21, wherein at least one of the one or more display regions configured to be visible on the screen is a pop-up display region previously configured to be invisible on the screen.

29. A method for facilitating video decompression in a screen-sharing application, comprising:
employing a microprocessor to execute computer executable components stored within a memory to perform the following:
decoding encoded bitstreams of one or more reference buffers, the one or more reference buffers corresponding to a number of one or more display regions of a screen, the encoded bitstreams being indicative of one or more properties of the one or more display regions of the screen and being indicative of ones of the display regions configured to be visible on the screen;
determining the ones of the display regions configured to be visible on the screen; and
displaying the display regions configured to be visible on the screen, wherein the displaying comprises rendering the display regions configured to be visible on the screen based, at least, on one or more properties of the display regions configured to be visible on the screen.

30. A system configured to facilitate video compression in a screen-sharing application, comprising:
a memory that stores computer executable components; and
a microprocessor that executes the following computer executable components stored in the memory:
a communication component configured to:
receive a first stream of video information configured for display at a first display region of a screen; and
receive a second stream of video information configured for display at a second display region of the screen;
a screen analysis component configured to:
determine one or more properties of the screen; and
determine one or more properties of the first display region and the second display region;
a hierarchy component configured to rank the first display region and the second display region based, at least, on whether the first display region or the second display region is configured to be visible on the screen, a high ranked display region being one that is configured to be visible on the screen;
an encoder configured to generate an encoded bitstream for the high ranked display region, the encoded bitstream including information indicative of the one or more properties of the high ranked display region; and
a resource allocation component configured to:
generate reference buffers for the first display region and the second display region, the reference buffers being associated with identifiers of the first display region and the second display region, and a one of the reference buffers for the high ranked display region comprising the encoded bitstream; and
delete the one or more reference buffers for the first display region and the second display region based, at least, on receipt of information indicative of the first display region or the second display region being deleted.

31. The system of claim 30, further comprising:
a decoder configured to decode the encoded bitstream;
a screen analysis component configured to:
analyze one or more bitstreams; and
determine one or more properties of at least one of the screen or the high ranked display region; and
a rendering component configured to display the high ranked display region configured to be visible on the screen, displaying being based, at least, on the one or more properties of at least one of the screen or the high ranked display region.

32. The system of claim 30, wherein the system is a web conferencing system.

33. A system configured to facilitate video decompression in a screen-sharing application, comprising:
a memory that stores computer executable components; and
a microprocessor that executes the following computer executable components stored in the memory:
a decoder configured to decode encoded bitstreams of one or more reference buffers, the one or more reference buffers corresponding to a number of one or more display regions of a screen, the encoded bitstreams being indicative of one or more properties of the one or more display regions of the screen and being indicative of ones of the display regions configured to be visible on the screen;
a decoder management component comprising:
a screen analysis component configured to determine the ones of the display regions configured to be visible on the screen; and
a rendering component configured to display the display regions determined by the screen analysis component to be configured to be visible on the screen, wherein the rendering component being configured to display comprises the rendering component being configured to the display regions configured to be visible on the screen based, at least, on one or more properties of the display regions.

34. The system of claim 33, further comprising:
a communication component configured to receive the encoded bitstreams of the one or more reference buffers.

35. A system configured to facilitate video decompression in a screen-sharing application, comprising:
a memory that stores computer executable components; and
a microprocessor that executes the following computer executable components stored in the memory:
a screen analysis component configured to receive encoded bitstreams indicative of video information for display on a first display region and a second display region of a screen, the encoded bitstreams being comprised in respective reference buffers associated with the first display region and the second display region;
a decoder configure to decode the encoded bitstreams; and
a rendering component configured to display the video information for display on the first display region and the second display region of the screen.

36. The system of claim 35, wherein the video information comprises information associated with at least one of a web conference or screencasting information.

37. The system of claim 35, wherein the encoded bitstreams are indicative of layer information for the first display region and the second display region, and wherein displaying the video information for display on the first display region and the second display region of the screen comprises displaying the first display region at a first layer of the screen and displaying the second display region at a second layer of the screen.

38. The system of claim 37, wherein the first display region and the second display region are configured to be visible on the screen.
